(19) United States
(12) Patent Application Publication
(10) Pub. No.: US 2024/0236970 A1
(43) Pub. Date: Jul. 11, 2024

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/611,746

(22) Filed: Mar. 21, 2024

Related U.S. Application Data
(63) Continuation of application No. PCT/CN2022/120902, filed on Sep. 23, 2022.

(30) Foreign Application Priority Data
Sep. 29, 2021 (CN) 202111150088.1

(51) Int. Cl. H04W 72/044; H04L 5/00; H04W 72/542

(52) U.S. Cl. CPC H04W 72/046; H04L 5/0051; H04W 72/542

(57) ABSTRACT

The communication node firstly receives a first message, the first message determining a first reference signal resource pool; and then transmits a first radio signal for beam management, the first radio signal indicating a first reference signal resource; and determines a first target reference signal resource set from the first reference signal resource pool according to at least the first reference signal resource; and increments a first counter by 1 whenever a first-type radio link quality evaluated according to the first target reference signal resource set is worse than a first threshold; and transmits a second radio signal as a response to the first counter reaching a first value, the second radio signal being used for beam failure recovery. This application optimizes the procedures related to beam management under multiple TRPs, which in turn optimizes the system performance.

### CROSS REFERENCE TO RELATED APPLICATIONS

This application is the continuation of the international application No. PCT/CN2022/120902, filed on Sep. 23,2022, and claims the priority benefit of Chinese patent application Ser. No. 20/211,1150088.1, filed on Sep. 29,2021, the full disclosure of which is incorporated herein by reference.

### BACKGROUND

### Technical Field

The present application relates to transmission methods and devices in wireless communication systems, and in particular to a transmission scheme and device for beam management and link recovery.

### Related Art

Traditional Network Controlled mobility includes cell level mobility and beam level mobility, where cell level mobility is dependent on Radio Resource Control (RRC) signaling and beam level mobility does not involve RRC signaling. Prior to the 3rd Generation Partnership Project (3GPP) R16, beam-level mobility was only available for beam management and so on within a single cell. The 3GPP RAN #80 meeting decided to launch a work item (WI) “Further enhancements on MIMO for NR” and provide support to multi-beam operations to ensure enhancements on Layer 1 (L1)/Layer 2 (L2) centric inter-cell mobility and inter-cell multiple Transmit/Receive Point (mTRP).

### SUMMARY

For NR systems, the 3GPP has introduced the Beam Failure Recovery (BFR) mechanism, where the UE (i.e., User Equipment) evaluates based on a reference signal set belonging to a serving cell, and if the number of times the evaluation result is worse than a predefined threshold reaches a predefined value, a BFR or Random Access (RA) procedure is triggered. In order to realize inter-cell L1/L2 mobility or inter-cell mTRP, when the UE is in the Serving Cell, the network configures at least one additional cell for the UE via an RRC message for the Serving Cell, and the UE can use the TRP of the additional cell for data transmission within the coverage of the Serving Cell. The additional cell and the serving cell have different Physical Cell Identifiers (PCIs).

In the existing NR system, the reference signal resource set for the measurement used to determine whether to trigger the BFR mechanism and the candidate reference signal resource set for selected reporting are obtained through the network side configuration, and the terminal equipment shall not trigger the change of the above two reference signal resource sets. Instead, during the beam management procedure, the terminal is able to implicitly inform the base station of which TRP it is covered by based on the PCI associated with the reported reference signal resource, and thus the reference signal resource reported during the beam management procedure described above can be applied to the BFR to improve the efficiency of the BFR process.

To address the above problem, the present application provides a solution. For the above problem description, the uu-interface scenario is used as an example; the present application is equally applicable to, for example, the sidelink scenario, to achieve similar technical effects as in the uu-interface scenario. Additionally, the adoption of a unified solution for various scenarios contributes to the reduction of hardcore complexity and costs. The present application is equally applicable to other scenarios facing similar problems (e.g., self-organizing networks, or scenarios where the central node is a non-base station node, or high-speed mobility scenarios, or for different application scenarios, such as eMBB and URLLC, where similar technical results can be achieved. Additionally, the adoption of a unified solution for various scenarios, including but not limited to eMBB and URLLC scenarios, contributes to the reduction of hardcore complexity and costs. In the case of no conflict, the embodiments of a first node and the characteristics in the embodiments may be applied to a second node, and vice versa. Particularly, for interpretations of the terminology, nouns, functions and variables (unless otherwise specified) in the present application, refer to definitions given in TS36 series, TS38 series and TS37 series of 3GPP specifications.

The present application provides a method in a first node for wireless communications, comprising:
receiving a first message, the first message being used to determine a first reference signal resource pool, the first reference signal resource pool comprising at least one reference signal resource; and
transmitting a first radio signal for beam management, the first radio signal indicating a first reference signal resource; and determining a first target reference signal resource set from the first reference signal resource pool according to at least the first reference signal resource; and
whenever a first-type radio link quality evaluated according to the first target reference signal resource set is worse than a first threshold, incrementing a first counter by 1; and as a response to the first counter reaching a first value, transmitting a second radio signal, the second radio signal being used for beam failure recovery;
herein, the second radio signal indicates a second reference signal resource; the second reference signal resource is related to the first target reference signal resource set.

In one embodiment, a technical feature of the above method lies in that the first reference signal resource reported by the first radio signal used for beam management is applied to the procedure of BFR to influence the first target reference signal resource set selected by the first node, that is, to influence a set of beams used for detecting whether the radio link has undergone a Beam Link Failure (BLF), for reflecting which TRP's coverage the first node is located under, or for reflecting which TRP the first node tends to be served by.

In one embodiment, another technical feature of the above method lies in that two TRPs, namely a first TRP and a second TRP, exist at the serving base station of the first node; when the first node discovers through a beam management procedure that it is under the coverage of beam signals from the first TRP, the first node monitors the beams in a beam set corresponding to the first TRP that are used for BLF monitoring to determine whether there is a BLF or not; when the first node discovers through the beam management procedure that it is under the coverage of beam signals from the second TRP, the first node monitors the beams in a beam set corresponding to the second TRP that are used for BLF monitoring to determine whether there is a BLF or not. Compared with the existing scheme, the above method better reflects the advantages and benefits brought about by the mTRP and reduces unnecessary power consumption of the terminal.

According to one aspect of the present application, the first reference signal resource pool comprises a first reference signal resource set and a second reference signal resource set; the first reference signal resource set and the second reference signal resource set are respectively associated with a first physical cell identifier and a second physical cell identifier; when the first reference signal resource is associated with the first physical cell identifier, the first target reference signal resource set is the first reference signal resource set; when the first reference signal resource is associated with the second physical cell identifier, the first target reference signal resource set is the second reference signal resource set.

According to one aspect of the present application, the second reference signal resource is a reference signal resource in a second target reference signal resource set; a second reference signal resource pool comprises a third reference signal resource set and a fourth reference signal resource set; the third reference signal resource set and the fourth reference signal resource set are respectively associated with a first physical cell identifier and a second physical cell identifier; when the first target reference signal resource set is associated with the first physical cell identifier, the second target reference signal resource set is the third reference signal resource set; when the first target reference signal resource set is associated with the second physical cell identifier, the second target reference signal resource set is the fourth reference signal resource set.

In one embodiment, a technical feature of the above method lies in that when a link is established between a set of beams used for BLF monitoring and the first reference signal resource reported for beam management, a set of beams to which recommended beams belong is also linked to the first reference signal resource; i.e., when the first node, by monitoring beams in the set of beams for BLF monitoring that corresponds to the first TRP, determines that a BLF has occurred, the first node selects one candidate beam in a set of candidate beams corresponding to the first TRP to be reported for BFR; when the first node, by monitoring beams in the set of beams for BLF monitoring that corresponds to the second TRP, determines that a BLF has occurred, the first node selects one candidate beam in a set of candidate beams corresponding to the second TRP to be reported for BFR.

According to one aspect of the present application, comprising:
receiving a first signaling;
herein, the first signaling is used to determine that a demodulation reference signal (DMRS) for a PDCCH in a control resource set 0 and the first reference signal resource are quasi co-located.

In one embodiment, the above method is technically characterized in that the reception of the first reference signal resource is acknowledged to the first node by the first signaling, whereby the spatial reception parameters corresponding to the first reference signal resource will be used for the reception of the control signaling transmitted in CORESET (i.e., Control Resource Set) #0.

According to one aspect of the present application, comprising:
receiving a second signaling in a first time-frequency resource set;
herein, the first time-frequency resource set is associated with a control resource set 0, and the second reference signal resource and a demodulation reference signal included in the first time-frequency resource set are quasi co-located.

In one embodiment, the above method is technically characterized in that when the first node reports the second reference signal resource through the BFR procedure, the spatial reception parameters corresponding to the second reference signal resource will be used for the reception of the control signaling transmitted in CORESET #0.

According to one aspect of the present application, the second reference signal resource is the first reference signal resource, or the second reference signal resource is quasi co-located with the first reference signal resource.

According to one aspect of the present application, comprising:
updating a reference signal resource associated with a first Transmission Configuration Indicator (TCI) State to the first reference signal resource;
herein, the first radio signal is used to determine the first TCI State.

In one embodiment, a technical feature of the above method lies in that the first reference signal resource reported during the beam management procedure can also be used to update a reference signal resource corresponding to the TCI state, and the above method avoids excessive interactions between the base station and the terminal, reduces signaling overhead, and improves efficiency.

According to one aspect of the present application, when the first node transmits the second radio signal, the second reference signal resource is updated in the second reference signal resource pool.

In one embodiment, a technical feature of the above method lies in that while reporting the second reference signal resource, the second reference signal resource is updated in a set of candidate reference signals for the selection of recommended reference signal resources in the subsequent BFR procedure, thereby further optimizing the BFR procedure and reducing signaling interactions.

The present application provides a method in a second node for wireless communications, comprising:
transmitting a first message, the first message being used to determine a first reference signal resource pool, the first reference signal resource pool comprising at least one reference signal resource; and
transmitting a first radio signal for beam management, the first radio signal indicating a first reference signal resource; and determining a first target reference signal resource set from the first reference signal resource pool according to at least the first reference signal resource; and
receiving a second radio signal, the second radio signal being used for beam failure recovery;
herein, a receiver of the first message includes a first node; whenever a first-type radio link quality evaluated by the first node according to the first target reference signal resource set is worse than a first threshold, a first counter is incremented by 1; and as a response to the first counter reaching a first value, the first node transmits a second radio signal; the second radio signal indicates a second reference signal resource; the second reference signal resource is related to the first target reference signal resource set.

According to one aspect of the present application, the first reference signal resource pool comprises a first reference signal resource set and a second reference signal resource set; the first reference signal resource set and the second reference signal resource set are respectively associated with a first physical cell identifier and a second physical cell identifier; when the first reference signal resource is associated with the first physical cell identifier, the first target reference signal resource set is the first reference signal resource set; when the first reference signal resource is associated with the second physical cell identifier, the first target reference signal resource set is the second reference signal resource set.

According to one aspect of the present application, the second reference signal resource is a reference signal resource in a second target reference signal resource set; a second reference signal resource pool comprises a third reference signal resource set and a fourth reference signal resource set; the third reference signal resource set and the fourth reference signal resource set are respectively associated with a first physical cell identifier and a second physical cell identifier; when the first target reference signal resource set is associated with the first physical cell identifier, the second target reference signal resource set is the third reference signal resource set; when the first target reference signal resource set is associated with the second physical cell identifier, the second target reference signal resource set is the fourth reference signal resource set.

According to one aspect of the present application, comprising:
transmitting a first signaling;
herein, the first signaling is used to determine that a demodulation reference signal (DMRS) for a PDCCH in a control resource set 0 and the first reference signal resource are quasi co-located.

According to one aspect of the present application, comprising:
transmitting a second signaling in a first time-frequency resource set;
herein, the first time-frequency resource set is associated with a control resource set 0,and the second reference signal resource and a demodulation reference signal included in the first time-frequency resource set are quasi co-located.

According to one aspect of the present application, the second reference signal resource is the first reference signal resource, or the second reference signal resource is quasi co-located with the first reference signal resource.

According to one aspect of the present application, comprising:
updating a reference signal resource associated with a first TCI State to the first reference signal resource;
herein, the first radio signal is used to determine the first TCI State.

According to one aspect of the present application, when the second node receives the second radio signal, the second reference signal resource is updated in the second reference signal resource pool.

The present application provides a first node for wireless communications, comprising:
a first receiver, receiving a first message, the first message being used to determine a first reference signal resource pool, the first reference signal resource pool comprising at least one reference signal resource; and
a first transmitter, transmitting a first radio signal for beam management, the first radio signal indicating a first reference signal resource; and determining a first target reference signal resource set from the first reference signal resource pool according to at least the first reference signal resource; and
a first transceiver, whenever time a first-type radio link quality evaluated according to the first target reference signal resource set is worse than a first threshold, incrementing a first counter by 1; and as a response to the first counter reaching a first value, transmitting a second radio signal, the second radio signal being used for beam failure recovery;
herein, the second radio signal indicates a second reference signal resource; the second reference signal resource is related to the first target reference signal resource set.

The present application provides a second node for wireless communications, comprising:
a second transmitter, transmitting a first message, the first message being used to determine a first reference signal resource pool, the first reference signal resource pool comprising at least one reference signal resource; and
a second receiver, transmitting a first radio signal for beam management, the first radio signal indicating a first reference signal resource; and determining a first target reference signal resource set from the first reference signal resource pool according to at least the first reference signal resource; and
a second transceiver, receiving a second radio signal, the second radio signal being used for beam failure recovery;
herein, a receiver of the first message includes a first node; whenever a first-type radio link quality evaluated by the first node according to the first target reference signal resource set is worse than a first threshold, a first counter is incremented by 1; and as a response to the first counter reaching a first value, the first node transmits a second radio signal; the second radio signal indicates a second reference signal resource; the second reference signal resource is related to the first target reference signal resource set.

In one embodiment, compared with the prior art, the present application is advantageous in the following aspects:
the first reference signal resource reported by the first radio signal used for beam management is applied to the procedure of BFR to influence the first target reference signal resource set selected by the first node, that is, to influence a set of beams used for detecting whether the radio link has undergone a BLF, for reflecting which TRP's coverage the first node is located under, or for reflecting which TRP the first node tends to be served by;
there exist two TRPs, namely a first TRP and a second TRP at the serving base station of the first node; when the first node discovers through a beam management procedure that it is under the coverage of beam signals from the first TRP, the first node monitors the beams in a beam set corresponding to the first TRP that are used for BLF monitoring to determine whether there is a BLF or not; when the first node discovers through the beam management procedure that it is under the coverage of beam signals from the second TRP, the first node monitors the beams in a beam set corresponding to the second TRP that are used for BLF monitoring to determine whether there is a BLF or not. Compared with the existing scheme, the above method better reflects the advantages and benefits brought about by the mTRP and reduces unnecessary power consumption of the terminal;
when a link is established between a set of beams used for BLF monitoring and the first reference signal resource reported for beam management, a set of beams to which recommended beams belong is also linked to the first reference signal resource; i.e., when the first node, by monitoring beams in the set of beams for BLF monitoring that corresponds to the first TRP, determines that a BLF has occurred, the first node selects one candidate beam in a set of candidate beams corresponding to the first TRP to be reported for BFR; when the first node, by monitoring beams in the set of beams for BLF monitoring that corresponds to the second TRP, determines that a BLF has occurred, the first node selects one candidate beam in a set of candidate beams corresponding to the second TRP to be reported for BFR;
when the first node reports the second reference signal resource through the BFR procedure, the spatial reception parameters corresponding to the second reference signal resource will be used for the reception of the control signaling transmitted in CORESET #0;
the first reference signal resource reported during the beam management procedure can also be used to update a reference signal resource corresponding to the TCI state, and the above method avoids excessive interactions between the base station and the terminal, reduces signaling overhead, and improves efficiency;
while reporting the second reference signal resource, the second reference signal resource is updated in a set of candidate reference signals for the selection of recommended reference signal resources in the subsequent BFR procedure, thereby further optimizing the BFR procedure and reducing signaling interactions.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of a first message according to one embodiment of the present application.

FIG. 6 illustrates a flowchart of a first signaling according to one embodiment of the present application.

FIG. 7 illustrates a flowchart of a second signaling according to one embodiment of the present application.

FIG. 8 illustrates a schematic diagram of an application scenario according to one embodiment of the present application.

FIG. 9 illustrates a structure block diagram of a processing device in a first node according to one embodiment of the present application.

FIG. 10 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

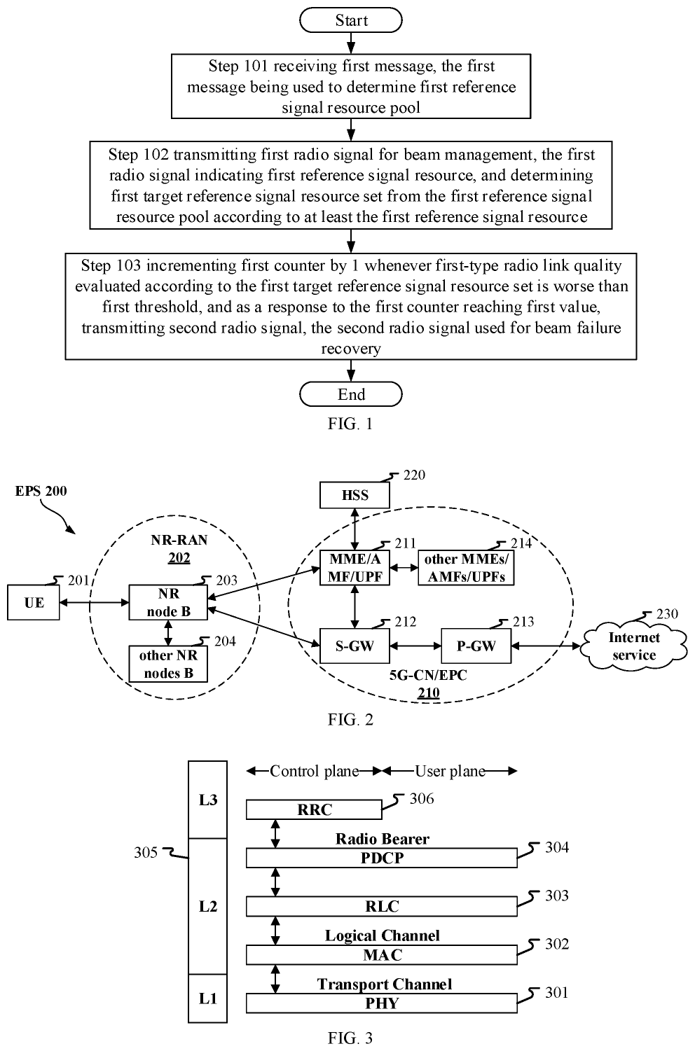

Embodiment 1 illustrates a flowchart of processing of a first node, as shown in FIG. 1. In 100 illustrated by FIG. 1, each box represents a step. In Embodiment 1, the first node in the present application receives a first message in step 101, the first message being used to determine a first reference signal resource pool; and transmits a first radio signal for beam management in step 102, the first radio signal indicating a first reference signal resource, and determines a first target reference signal resource set from the first reference signal resource pool according to at least the first reference signal resource; and in step 103, increments a first counter by 1 whenever a first-type radio link quality evaluated according to the first target reference signal resource set is worse than a first threshold, and as a response to the first counter reaching a first value, transmits a second radio signal, the second radio signal being used for beam failure recovery.

In Embodiment 1, the first reference signal resource pool comprises at least one reference signal resource, the second radio signal indicating a second reference signal resource; the second reference signal resource is related to the first target reference signal resource set.

In one embodiment, the first message is used to implicitly indicate the first reference signal resource set.

In one embodiment, the first message is used to explicitly indicate the first reference signal resource set.

In one embodiment, a transmitter of the first message is a maintenance base station of a serving cell of the first node.

In one embodiment, the first message is transmitted via a uu interface.

In one embodiment, the first message is transmitted via a PC5 interface.

In one embodiment, a logical channel of the first message includes a Broadcast Control Channel (BCCH), or a Dedicated Control Channel (DCCH), or a Common Control Channel (CCCH), or a Sidelink Control Channel (SCCH), or a Sidelink Broadcast Control Channel (SBCCH).

In one embodiment, the first message comprises a Downlink (DL) signaling.

In one embodiment, the first message comprises a Sidelink, (SL) signaling.

In one embodiment, the first message is an RRC message.

In one embodiment, the first message comprises at least one RRC message.

In one embodiment, the first message comprises at least one Information Element (IE) in an RRC message.

In one embodiment, the first message comprises at least one Field in an RRC message.

In one embodiment, the first message comprises an RRCReconfiguration message.

In one embodiment, the first message comprises a System Information Block 1 (SIB1) message.

In one embodiment, the first message comprises a SystemInformation message.

In one embodiment, the first message is a field or an IE other than an IE RadioLinkMonitoringConfig.

In one embodiment, the first message comprises at least one IE other than an IE RadioLinkMonitoringConfig.

In one embodiment, the first message comprises M sub-signalings, of which each sub-signaling comprises an IE RadioLinkMonitoringConfig, M being a number of Bandwidth Parts (BWPs).

In one embodiment, the first message comprises at least an IE RadioLinkMonitoringConfig.

In one embodiment, the first message comprises at least two IEs RadioLinkMonitoringConfig.

In one subembodiment of the above embodiment, the two IEs RadioLinkMonitoringConfig are respectively for the first PCI and the second PCI in this application.

In one embodiment, the first message comprises at least a failureDetectionResourcesToAddModList field.

In one embodiment, the first message comprises at least two failureDetectionResourcesToAddModList fields.

In one subembodiment of the above embodiment, the two failureDetectionResourcesToAddModList fields are respectively for the first PCI and the second PCI in this application.

In one embodiment, the first message is a failureDetectionResourcesToAddModList field.

In one embodiment, at least one IE or at least one field in the first message other than an IE RadioLinkMonitoringConfig indicates the first reference signal resource pool.

In one subembodiment, the first message comprises at least one ControlResourceSet IE, at least one field in the ControlResourceSet IE indicating the first reference signal resource pool.

In one subembodiment, the first message comprises at least one TCI-State IE, at least one field in the TCI-State IE indicating the first reference signal resource pool.

In one subembodiment, the first message comprises at least one referenceSignal field, the at least one referenceSignal field indicating the first reference signal resource pool.

In one subembodiment, an IE RadioLinkMonitoringConfig in the first message is used to indicate the first reference signal resource pool.

In one subembodiment, at least one RadioLinkMonitoringRS field in the first message is used to configure a Reference Signal (RS) Resource in the first reference signal resource pool, with a purpose field of the RadioLinkMonitoringRS field set to rlf or both.

In one subembodiment, at least one detectionResource field in the first message is used to configure at least one of an index or a type of an RS resource in the first reference signal resource pool.

In one embodiment, the meaning of the phrase of the first message being used to determine a first reference signal resource pool includes: the first message explicitly indicating at least one reference signal resource in the first reference signal resource pool.

In one embodiment, the meaning of the phrase of the first message being used to determine a first reference signal resource pool includes: the first message implicitly indicating at least one reference signal resource in the first reference signal resource pool.

In one embodiment, the meaning of the phrase of the first message being used to determine a first reference signal resource pool includes: the first message being used to configure at least one reference signal resource in the first reference signal resource pool.

In one embodiment, the meaning of the phrase of the first message being used to determine a first reference signal resource pool includes: the first message indicating at least one reference signal resource in the first reference signal resource pool.

In one embodiment, the meaning of the phrase of the first message being used to determine a first reference signal resource pool includes: the first message indicating an index of each reference signal resource in the first reference signal resource pool.

In one embodiment, the meaning of the phrase of the first message being used to determine a first reference signal resource pool includes: each reference signal resource in the first reference signal resource pool being configured by the first message.

In one embodiment, the meaning of the phrase of the first message being used to determine a first reference signal resource pool includes: reference signal resources in the first reference signal resource pool being reference signal resources indicated by the first message.

In one embodiment, the first reference signal resource pool comprises M1 reference signal resource(s), M1 being a positive integer no greater than M and M being a positive integer.

In one subembodiment, M is equal to 1.

In one subembodiment, M is equal to 2.

In one subembodiment, M is equal to 4.

In one subembodiment, M is no greater than 32.

In one embodiment, at least one reference signal resource in the first reference signal resource pool is a Channel State Information Reference Signal (CSI-RS) resource.

In one embodiment, at least one reference signal resource in the first reference signal resource pool is a Synchronization Signal Block (SSB).

In one embodiment, at least one reference signal resource in the first reference signal resource pool is a Synchronization Signal (SS)/Physical Broadcast Channel (PBCH) block.

In one embodiment, at least one reference signal resource in the first reference signal resource pool corresponds to a TCI-State.

In one embodiment, at least one reference signal resource in the first reference signal resource pool corresponds to a TCI-StateId.

In one embodiment, any reference signal resource in the first reference signal resource pool is periodic.

In one embodiment, any reference signal resource in the first reference signal resource pool is aperiodic.

In one embodiment, any reference signal resource in the first reference signal resource pool is QCL-Type D.

In one embodiment, one reference signal resource in the first reference signal resource pool is a CSI-RS resource identified by csi-RS-Index, or the one reference signal resource is an SSB resource identified by ssb-Index.

In one embodiment, one reference signal resource in the first reference signal resource pool is a CSI-RS resource identified by csi-rs, or the one reference signal resource is an SSB resource identified by ssb.

In one embodiment, one reference signal resource in the first reference signal resource pool is a CSI-RS resource identified by NZP-CSI-RS-ResourceId, or the one reference signal resource is an SSB resource identified by SSB-Index.

In one embodiment, the first reference signal resource pool is used for Radio Link Monitoring (RLM).

In one embodiment, the first reference signal resource pool is used for Link recovery procedures.

In one embodiment, any reference signal resource in the first reference signal resource pool is transmitted by a TRP of a maintenance base station of a cell identified by the first PCI in this application.

In one embodiment, the first reference signal resource pool is one q̅₀ in TS 38.213.

In one embodiment, the first reference signal resource pool corresponds to q̅₀ in TS 38.213.

In one embodiment, the first reference signal resource pool is two q̅₀ in TS 38.213.

In one embodiment, the first reference signal resource pool corresponds to two q̅₀s in TS 38.213.

In one embodiment, the first reference signal resource pool is configured on one BWP.

In one embodiment, the first reference signal resource pool is determined by failureDetectionResources or beamFailureDetectionResourceList.

In one embodiment, the first target reference signal resource set is determined based on a reference signal set indicated in a TCI state corresponding to a Control resource set (CORESET) used to listen on the Physical Downlink Control Channel (PDCCH).

In one embodiment, the first target reference signal resource set is determined by the first node.

In one embodiment, the meaning of the sentence “whenever a first-type radio link quality evaluated according to the first target reference signal resource set is worse than a first threshold, incrementing a first counter by 1” includes that: the first-type radio link quality evaluated according to the first target reference signal resource set being worse than a first threshold triggers the increment of the first counter by 1.

In one embodiment, the meaning of the sentence “whenever a first-type radio link quality evaluated according to the first target reference signal resource set is worse than a first threshold, incrementing a first counter by 1” includes that: only if the first-type radio link quality evaluated according to the first target reference signal resource set is worse than a first threshold will the first counter be incremented by 1; if the first-type radio link quality evaluated according to the first target reference signal resource set is not worse than the first threshold, the first counter is not incremented by 1.

In one embodiment, the meaning of the sentence “whenever a first-type radio link quality evaluated according to the first target reference signal resource set is worse than a first threshold, incrementing a first counter by 1” includes that: if the first-type radio link quality evaluated according to the first target reference signal resource set is worse than a first threshold, reporting to upper layers an indication of the first type, and only upon reception of the indication of the first type at the upper layers will the first counter be incremented by 1.

In one embodiment, if the first target reference signal resource set is reconfigured at a higher layer, setting the first counter to 0.

In one embodiment, if a beam failure recovery timer associated with the first counter expires, setting the first counter to 0.

In one embodiment, the meaning of whenever includes: once, or, as long as, or, if.

In one embodiment, the phrase that a first-type radio link quality evaluated according to the first target reference signal resource set is worse than a first threshold includes that: radio link qualities for all reference signal resources in the first target reference signal resource set are worse than the first threshold.

In one embodiment, the phrase that a first-type radio link quality evaluated according to the first target reference signal resource set is worse than a first threshold includes that: the radio link quality for each reference signal resource in the first target reference signal resource set is lower than the first threshold.

In one embodiment, the phrase that a first-type radio link quality evaluated according to the first target reference signal resource set is worse than a first threshold includes that: the radio link quality for each reference signal resource in the first target reference signal resource set is higher than the first threshold.

In one embodiment, a first-type radio link quality is evaluated according to the first target reference signal resource set at each evaluation period.

In one embodiment, the evaluation period of the first-type radio link quality comprises at least 1 time unit.

In one embodiment, the time unit comprises at least one of slot(s), or subframe(s), or Radio Frame(s), or frame(s), or multiple Orthogonal Frequency Division Multiplexing (OFDM) symbols, or multiple Single Carrier Frequency Division Multiple Access (SC-FDMA) symbols.

In one embodiment, the time unit comprises a time interval of at least 1 millisecond (ms).

In one embodiment, the evaluation period of the first-type radio link quality is 1 Frame.

In one embodiment, the evaluation period of the first-type radio link quality is 1 Radio Frame.

In one embodiment, the first threshold is configurable.

In one embodiment, the first threshold is pre-configured.

In one embodiment, the first threshold is configured via an RRC message.

In one embodiment, the first threshold includes a Block Error Ratio (BLER) threshold.

In one embodiment, the first threshold includes a Reference Signal Received Power (RSRP) threshold.

In one embodiment, the first threshold includes a Reference Signal Received Quality (RSRQ) threshold.

In one embodiment, the first threshold includes a Signal-to-noise ratio (SNR) threshold.

In one embodiment, the first threshold includes a Signal to Interference plus Noise Ratio (SINR) threshold.

In one embodiment, the first threshold is measured in dBm.

In one embodiment, the first threshold is measured in dB.

In one embodiment, the first threshold comprises Qₒᵤₜ.

In one embodiment, the first threshold is indicated by a field in an RRC message.

In one embodiment, the first threshold is indicated by an RRC message.

In one embodiment, the first threshold is indicated by a field in an RRC message, where a name of the field includes rlmInSyncOutOfSyncThreshold.

In one embodiment, the first threshold is indicated by a field in an RRC message, where a name of the field includes rsrp-ThresholdSSB.

In one embodiment, the first threshold is indicated by a field in an RRC message, where a name of the field includes rsrp-ThresholdBFR.

In one embodiment, whenever a first-type radio link quality evaluated according to the first target reference signal resource set is worse than a first threshold, reporting an indication of a first type to a target higher layer during a reporting period corresponding to the evaluation period.

In one embodiment, the reporting period for the first-type radio link quality comprises at least 1 slot.

In one embodiment, the reporting period for the first-type radio link quality is 2 milliseconds (ms).

In one embodiment, the reporting period for the first-type radio link quality is 10 milliseconds (ms).

In one embodiment, the reporting period for the first-type radio link quality is a shortest period for all reference signal resources in the first target reference signal resource set.

In one embodiment, the action of as a response to the first counter reaching a first value also includes:

a PHY layer of the first node transmits the indication of a first type to a higher layer of the first node via an interlayer interface.

In one subembodiment, the indication of the first type is used to indicate to the target higher layer that a first-type radio link quality evaluated according to the first target reference signal resource set is worse than a first threshold.

In one subembodiment, the indication of the first type is used to indicate to the target higher layer a beam failure.

In one subembodiment, the indication of the first type is a beam failure instance indication.

In one subembodiment, the indication of the first type is for a cell identified by the first PCI, or the indication of the first type is for a cell identified by the second PCI.

In one embodiment, whenever a first-type radio link quality evaluated according to the first target reference signal resource set is worse than a first threshold, a physical layer of the first node reports to a target higher layer of the first node an indication of a second type, and as a response to reception of the indication of the second type at the target higher layer of the first node, the first counter is incremented by 1.

In one embodiment, the action of “incrementing a first counter by 1” comprises: increasing the count value of the first counter by 1.

In one embodiment, the action of “incrementing a first counter by 1” comprises: incrementing the first counter by 1.

In one embodiment, the first counter is used to count the number of indications of the second type in the present application.

In one embodiment, the first counter is BFI_COUNTER.

In one embodiment, a name of the first counter includes at least one of BFI or COUNTER or TRP or RS or Set or per or Per.

In one embodiment, the first counter is for the cell identified by the first PCI, or the first counter is for the cell identified by the second PCI.

In one embodiment, the first counter is for a TRP in the cell identified by the first PCI, or the first counter is for a TRP in the cell identified by the second PCI.

In one embodiment, the first counter is configured in the first node.

In one embodiment, the first counter is a counter attached to the first node.

In one embodiment, the first-type radio link quality includes at least one of RSRP, RSRQ, Received Signal Strength Indication (RSSI), SNR or SINR.

In one embodiment, the first-type radio link quality is the quality for radio links.

In one embodiment, the first-type radio link quality is the quality between a maintenance base station of a cell identified by the first PCI and the first node.

In one embodiment, the first-type radio link quality is the quality between a maintenance base station of a cell identified by the second PCI and the first node.

In one embodiment, the first-type radio link quality is the quality between at least one TRP in a cell identified by the first PCI and the first node.

In one embodiment, the first-type radio link quality is the quality between at least one TRP in a cell identified by the second PCI and the first node.

In one embodiment, the first-type radio link quality is the quality between all TRPs in a cell identified by the first PCI and the first node.

In one embodiment, the first-type radio link quality is the quality between all TRPs in a cell identified by the second PCI and the first node.

In one embodiment, the beam management in the present application comprises network control-based beam management.

In one embodiment, the beam management in the present application comprises beam management based on control of the second node.

In one embodiment, the beam management in the present application comprises beam management initiated by the first node.

In one embodiment, the beam management in the present application comprises beam management initiated by the UE.

In one embodiment, the beam management procedure in the present application comprises the beam management.

In one embodiment, the beam management in the present application is not part of the beam failure detection and recovery procedure.

In one embodiment, the beam management in the present application is not part of the beam failure detection procedure.

In one embodiment, the beam management in the present application is not part of the beam failure recovery procedure.

In one embodiment, the beam management in the present application does not include: receiving an indication from a lower layer.

In one embodiment, the beam management in the present application does not include: starting or restarting a timer as a response to receiving the indication from a lower layer.

In one embodiment, the beam management in the present application does not include: incrementing a counter by 1 as a response to receiving an indication from a lower layer.

In one embodiment, the beam management in the present application does not include: incrementing a first counter by 1 whenever a first-type radio link quality evaluated according to the first reference signal resource set is worse than a first threshold.

In one embodiment, the beam management in the present application is not dependent on an evaluation of the first reference signal resource set.

In one embodiment, the beam management in the present application is not dependent on whether the first counter reaches a given value.

In one embodiment, the beam management in the present application is not dependent on the beam failure detection procedure.

In one embodiment, the beam management in the present application comprises beam refinement.

In one embodiment, the beam management in the present application comprises beam tracking.

In one embodiment, the beam management in the present application comprises beam adjustment.

In one embodiment, the beam management in the present application comprises beam level mobility.

In one embodiment, the beam management in the present application comprises beam handover.

In one embodiment, the beam management in the present application comprises beam change.

In one embodiment, the beam management in the present application comprises beam switch.

In one embodiment, the beam management in the present application comprises beam measurement.

In one embodiment, the beam management in the present application comprises beam reporting.

In one embodiment, the beam management in the present application comprises changing a Quasi Co-located (QCL) relationship of a reference signal resource.

In one embodiment, the beam management in the present application comprises changing a TCI state of a physical channel.

In one embodiment, the beam management in the present application comprises changing a TCI state corresponding to a CORESET of a physical channel.

In one embodiment, the beam management in the present application comprises changing a correspondence between a TCI and a reference signal resource.

In one embodiment, the beam management in the present application comprises Channel State Information (CSI) reporting.

In one embodiment, the beam management in the present application comprises Beam Level Measurement.

In one embodiment, the beam management in the present application comprises Beam Level Mobility.

In one embodiment, the beam management in the present application does not require Explicit RRC Signaling to be triggered.

In one embodiment, the beam management in the present application comprises beam adjustment below the RRC layer.

In one embodiment, the beam management in the present application does not comprise BFR.

In one embodiment, the beam management in the present application does not comprise Cell Level mobility management.

In one embodiment, the first radio signal is transmitted via Uplink control information (UCI).

In one embodiment, a physical layer channel occupied by the first radio signal includes a Physical Uplink Shared Channel (PUSCH).

In one embodiment, the first radio signal is a CSI.

In one embodiment, the first radio signal is transmitted through a beam management procedure.

In one embodiment, the first radio signal implicitly indicates a first reference signal resource.

In one subembodiment, at least one of a location of a frequency-domain resource occupied by the first radio signal or a location of a time-domain resource occupied by the first radio signal is used to indicate the first reference signal resource.

In one subembodiment, a scrambling employed by a demodulation reference signal included in the first radio signal is used to indicate the first reference signal resource.

In one embodiment, the first radio signal explicitly indicates the first reference signal resource.

In one embodiment, the first reference signal resource is a CSI-RS resource.

In one embodiment, the first reference signal resource is an SSB resource.

In one embodiment, the first reference signal resource is an SS/Physical Broadcast Channel (PBCH) block.

In one embodiment, the first reference signal resource corresponds to a TCI-State.

In one embodiment, the first reference signal resource corresponds to a TCI-StateId.

In one embodiment, a radio channel quality determined by the first node based on a reference signal transmitted in the first reference signal resource is greater than a second threshold, the second threshold being fixed, or the second threshold being configured by RRC signaling.

In one subembodiment of the above embodiment, the second threshold comprises a BLER threshold.

In one subembodiment of the above embodiment, the second threshold comprises a RSRP threshold.

In one subembodiment of the above embodiment, the second threshold comprises a RSRQ threshold.

In one subembodiment of the above embodiment, the second threshold comprises a SNR threshold.

In one subembodiment of the above embodiment, the second threshold comprises a SINR threshold.

In one subembodiment of the above embodiment, the second threshold is measured in a unit of dBm.

In one subembodiment of the above embodiment, the second threshold is measured in a unit of dB.

In one embodiment, the above phrase of determining a first target reference signal resource set from the first reference signal resource pool according to at least the first reference signal resource comprises: the first node transmits a first radio signal and, upon receiving feedback for the first radio signal, determines the first target reference signal resource set from the first reference signal resource pool according to the first reference signal resource.

In one subembodiment, the feedback for the first radio signal is transmitted by the second node in this application.

In one subembodiment, the feedback for the first radio signal is transmitted by at least one TRP in a cell identified by the first PCI.

In one subembodiment, the feedback for the first radio signal is transmitted by at least one TRP in a cell identified by the second PCI.

In one subembodiment, the feedback for the first radio signal comprises a Hybrid Automatic Repeat reQuest Acknowledgement (HARQ-ACK).

In one subembodiment, the feedback for the first radio signal comprises a Physical Downlink Control Channel (PDCCH).

In one subembodiment, the feedback for the first radio signal comprises Medium Access Control (MAC) Control Elements (CE).

In one subembodiment, a physical layer channel occupied by the feedback for the first radio signal includes a Physical Downlink Shared Channel (PDSCH).

In one subembodiment, the feedback for the first radio signal is used to determine that the first reference signal resource is QCL with a demodulation reference signal resource of a PDCCH in CORESET #0.

In one subembodiment, the feedback for the first radio signal is used to determine that spatial reception parameters corresponding to the first reference signal resource can be used for demodulation of a PDCCH in CORESET #0.

In one embodiment, the above phrase of determining a first target reference signal resource set from the first reference signal resource pool according to at least the first reference signal resource comprises: the first node, after transmitting a first radio signal and determining that the first reference signal resource is QCL with a demodulation reference signal resource of a PDCCH in CORESET #0, determines the first target reference signal resource set from the first reference signal resource pool according to the first reference signal resource.

In one embodiment, the above phrase of determining a first target reference signal resource set from the first reference signal resource pool according to at least the first reference signal resource comprises: the first node, after transmitting a first radio signal and determining that spatial reception parameters corresponding to the first reference signal resource can be used for demodulation of a PDCCH in CORESET #0, determines the first target reference signal resource set from the first reference signal resource pool according to the first reference signal resource.

In one embodiment, the reference signal resource in the present application is a CSI-RS resource.

In one embodiment, the reference signal resource in the present application is an SSB resource.

In one embodiment, the reference signal resource in the present application is an SS/Physical Broadcast Channel (PBCH) block.

In one embodiment, the reference signal resource in the present application corresponds to a TCI-State.

In one embodiment, the reference signal resource in the present application corresponds to a TCI-StateId.

In one embodiment, the first reference signal resource pool comprises Q reference signal resource sets, Q being a positive integer greater than 1, and any candidate reference signal resource set among the Q reference signal resource sets comprising at least one reference signal resource.

In one subembodiment, Q is equal to 2, and the Q candidate reference signal resource sets are a first reference signal resource set and a second reference signal resource set, respectively.

In one subsidiary embodiment of the above subembodiment, the first reference signal resource set is associated with the first PCI.

In one subsidiary embodiment of the above subembodiment, the second reference signal resource set is associated with the second PCI.

In one subsidiary embodiment of the above subembodiment, the first target reference signal resource set is one of the first reference signal resource set or the second reference signal resource set.

In one subembodiment, Q is greater than 2, and the Q reference signal resource sets are respectively associated with Q different PCIs.

In one subsidiary embodiment of the above subembodiment, the first target reference signal resource set is one of the Q reference signal resource sets.

In one embodiment, the first reference signal resource pool is q̅₀ in TS 38.213.

In one embodiment, the first reference signal resource pool corresponds to q̅₀ in TS 38.213.

In one embodiment, the first reference signal resource pool is configured on one BWP.

In one embodiment, the first reference signal resource pool is configured by a BeamFailureRecoveryConfig IE.

In one embodiment, the name of an RRC signaling that configures the first reference signal resource pool includes Beam.

In one embodiment, the name of an RRC signaling that configures the first reference signal resource pool includes Failure.

In one embodiment, the name of an RRC signaling that configures the first reference signal resource pool includes Recovery.

In one embodiment, the first reference signal resource pool is configured via failureDetectionResourcesToAddModList in TS 38.331.

In one embodiment, the first reference signal resource pool is configured via failureDetectionResourcesToReleaseList in TS 38.331.

In one embodiment, the first reference signal resource pool is configured via RadioLinkMonitoringRS in TS 38.331.

In one embodiment, the signaling configuring the first reference signal resource pool also includes the first PCI and the second PCI.

In one embodiment, the second radio signal is a MAC CE.

In one embodiment, a physical layer channel occupied by the second radio signal includes a Physical Random Access Channel (PRACH).

In one embodiment, a physical layer channel occupied by the second radio signal includes a PUSCH.

In one embodiment, the beam management does not include the beam failure recovery.

In one embodiment, the first counter is a BFI_COUNTER and any BFI_COUNTER is not used to trigger the first radio signal.

In one embodiment, the second reference signal resource is a CSI-RS resource.

In one embodiment, the second reference signal resource is an SSB resource.

In one embodiment, the second reference signal resource is an SS/Physical Broadcast Channel (PBCH) block.

In one embodiment, the second reference signal resource corresponds to a TCI-State.

In one embodiment, the second reference signal resource corresponds to a TCI-StateId.

In one embodiment, the second reference signal resource is q_{new}.

In one embodiment, the second radio signal implicitly indicates a second reference signal resource.

In one subembodiment, at least one of a location of a frequency-domain resource occupied by the second radio signal or a location of a time-domain resource occupied by the second radio signal is used to indicate the second reference signal resource.

In one subembodiment, a scrambling employed by a demodulation reference signal included in the second radio signal is used to indicate the second reference signal resource.

In one subembodiment, a sequence generating the second radio signal is used to indicate the second reference signal resource.

In one embodiment, the second radio signal explicitly indicates a second reference signal resource.

In one embodiment, time-frequency resources occupied by the first radio signal are configured by RRC signaling.

In one embodiment, time-frequency resources occupied by the first radio signal are periodic.

### Embodiment 2

Embodiment 2 illustrates a schematic diagram of a network architecture, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one UE 201, an NR-RAN 202, a Evolved Packet Core (EPC)/5G-Core Network (5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NR-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field(AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 is a UE.

In one embodiment, the UE 201 is an ender.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a NodeB (NB), or a gNB, or an eNB, or an ng-eNB, or an en-gNB, or a UE, or a relay, or a Gateway, or at least one TRP.

In one embodiment, the node 203 comprises at least one TRP.

In one embodiment, the node 203 comprises at least one TRP in a cell identified by the first PCI, and the node 203 comprises at least one TRP in a cell identified by the second PCI.

In one embodiment, the node 203 is a logical node.

In one embodiment, different structures in the node 203 are located in the same entity.

In one embodiment, different structures in the node 203 are located in different entities.

In one embodiment, the UE supports transmissions in Non-Terrestrial Network (NTN).

In one embodiment, the UE supports transmissions in Terrestrial Network (TN).

In one embodiment, the UE supports transmissions in large-delay-difference networks.

In one embodiment, the UE supports Dual Connection (DC) transmissions.

In one embodiment, the UE supports NR.

In one embodiment, the UE supports UTRA.

In one embodiment, the UE supports EUTRA.

In one embodiment, the UE comprises a piece of equipment supporting transmissions with low delay and high reliability.

In one embodiment, the UE includes an aircraft, or a vehicle-mounted terminal, or a vessel, or an IoT terminal, or an IIoT terminal, or testing equipment, or a signaling test instrument.

In one embodiment, the base station supports transmissions in NTN.

In one embodiment, the base station supports transmissions in large-delay-difference networks.

In one embodiment, the base station supports transmissions in TN.

In one embodiment, the base station comprises a base station device supporting large time-delay difference.

In one embodiment, the base station comprises a Macro Cellular base station, or a Micro Cell base station, or a Pico Cell base station, or a Femtocell base station.

In one embodiment, the base station comprises a piece of flight platform equipment, or satellite equipment, or Transmitter Receiver Point (TRP), or a Centralized Unit (CU), or a Distributed Unit (DU), or test equipment, or signaling tester, or an Integrated Access and Backhaul (IAB)-node, or an IAB-donor, or an IAB-donor-CU, or an IAB-donor-DU, or an IAB-DU, or an IAB-MT.

In one embodiment, the relay includes a relay, or L3 relay, or L2 relay, or a Router, or an Exchanger.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), is represented by three layers, i.e., layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first communication node and a second communication node via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the second communication node between first communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The Radio Resource Control (RRC) sublayer 306 in the L3 is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP 304 of the second communication node is used for generating scheduling of the first communication node.

In one embodiment, the PDCP 354 of the second communication node is used for generating scheduling of the first communication node.

In one embodiment, the first message in the present application is generated by the RRC 306.

In one embodiment, the first message in the present application is generated by the MAC 302 or the MAC 352.

In one embodiment, the first message in the present application is generated by the PHY 301 or the PHY 351.

In one embodiment, the first radio signal in the present application is generated by the RRC 306.

In one embodiment, the first radio signal in the present application is generated by the MAC 302 or the MAC 352.

In one embodiment, the first radio signal in the present application is generated by the PHY 301 or the PHY 351.

In one embodiment, the second radio signal in the present application is generated by the RRC 306.

In one embodiment, the second radio signal in the present application is generated by the MAC 302 or the MAC 352.

In one embodiment, the second radio signal in the present application is generated by the PHY 301 or the PHY 351.

In one embodiment, the first signaling in the present application is generated by the MAC 302 or the MAC 352.

In one embodiment, the first signaling in the present application is generated by the PHY 301 or the PHY 351.

In one embodiment, the second signaling in the present application is generated by the RRC 306.

In one embodiment, the second signaling in the present application is generated by the MAC 302 or the MAC 352.

In one embodiment, the second signaling in the present application is generated by the PHY 301 or the PHY 351.

In one embodiment, the first node is a terminal/ender.

In one embodiment, the second node is a terminal/ender.

In one embodiment, the second node is a Transmitter Receiver Point (TRP).

In one embodiment, the second node is a cell.

In one embodiment, the second node is an eNB.

In one embodiment, the second node is a base station.

In one embodiment, the second node is used for managing multiple TRPs.

In one embodiment, the second node is used for managing multiple nodes of cells.

In one embodiment, the second node is used for managing multiple nodes of carriers.

### Embodiment 4

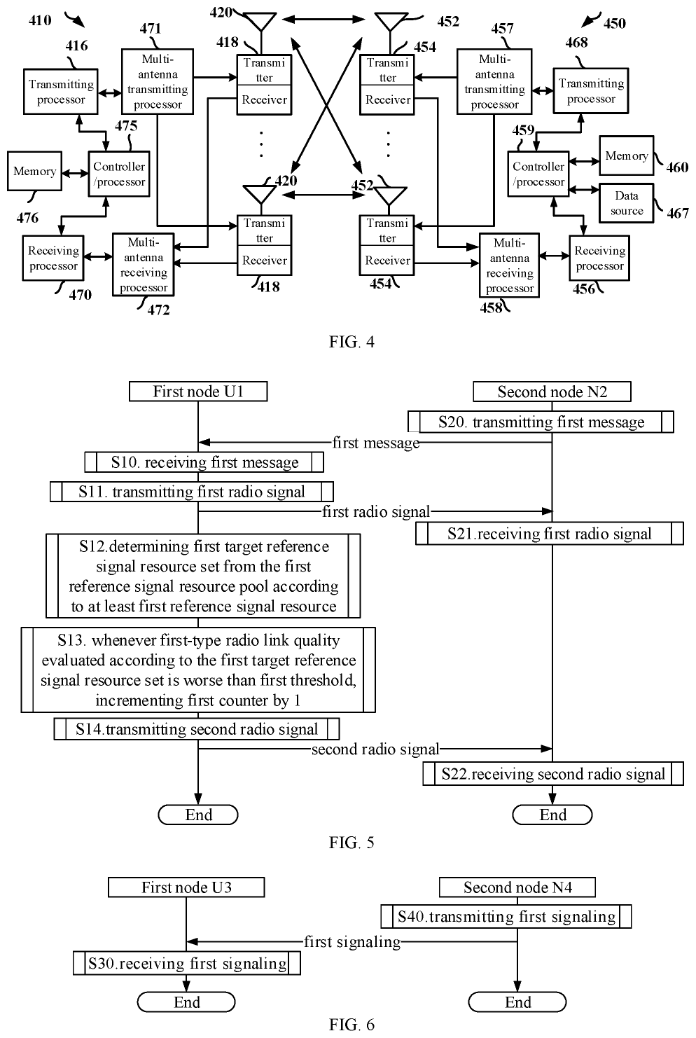

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data. The memory 460 may be called a computer readable medium. In the transmission from the second communication device 410 to the first communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least firstly receives a first message, the first message being used to determine a first reference signal resource pool, the first reference signal resource pool comprising at least one reference signal resource; and transmits a first radio signal for beam management, the first radio signal indicating a first reference signal resource; and determines a first target reference signal resource set from the first reference signal resource pool according to at least the first reference signal resource; and afterwards, increments a first counter by 1 whenever a first-type radio link quality evaluated according to the first target reference signal resource set is worse than a first threshold; and as a response to the first counter reaching a first value, transmits a second radio signal, the second radio signal being used for beam failure recovery; the second radio signal indicates a second reference signal resource; the second reference signal resource is related to the first target reference signal resource set.

In one embodiment, the first communication device 450 comprises a memory that stores a computer readable instruction program. The computer readable instruction program generates actions when executed by at least one processor. The actions include: firstly receiving a first message, the first message being used to determine a first reference signal resource pool, the first reference signal resource pool comprising at least one reference signal resource; and transmitting a first radio signal for beam management, the first radio signal indicating a first reference signal resource; and determining a first target reference signal resource set from the first reference signal resource pool according to at least the first reference signal resource; and afterwards, incrementing a first counter by 1 whenever a first-type radio link quality evaluated according to the first target reference signal resource set is worse than a first threshold; and as a response to the first counter reaching a first value, transmitting a second radio signal, the second radio signal being used for beam failure recovery; the second radio signal indicates a second reference signal resource; the second reference signal resource is related to the first target reference signal resource set.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: firstly transmits a first message, the first message being used to determine a first reference signal resource pool, the first reference signal resource pool comprising at least one reference signal resource; and then transmits a first radio signal for beam management, the first radio signal indicating a first reference signal resource; and determines a first target reference signal resource set from the first reference signal resource pool according to at least the first reference signal resource; and then receives a second radio signal, the second radio signal being used for beam failure recovery; a receiver of the first message includes a first node; whenever a first-type radio link quality evaluated by the first node according to the first target reference signal resource set is worse than a first threshold, a first counter is incremented by 1; and as a response to the first counter reaching a first value, the first node transmits a second radio signal; the second radio signal indicates a second reference signal resource; the second reference signal resource is related to the first target reference signal resource set.

In one embodiment, the second communication device 410 comprises a memory that stores a computer readable instruction program. The computer readable instruction program generates actions when executed by at least one processor. The actions include: firstly transmitting a first message, the first message being used to determine a first reference signal resource pool, the first reference signal resource pool comprising at least one reference signal resource; and then transmitting a first radio signal for beam management, the first radio signal indicating a first reference signal resource; and determining a first target reference signal resource set from the first reference signal resource pool according to at least the first reference signal resource; and then receiving a second radio signal, the second radio signal being used for beam failure recovery; a receiver of the first message includes a first node; whenever a first-type radio link quality evaluated by the first node according to the first target reference signal resource set is worse than a first threshold, a first counter is incremented by 1; and as a response to the first counter reaching a first value, the first node transmits a second radio signal; the second radio signal indicates a second reference signal resource; the second reference signal resource is related to the first target reference signal resource set.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a terminal.

In one embodiment, the first communication device 450 can recognize multiple TRPs under a base station.

In one embodiment, the second communication device 410 is a base station.

In one embodiment, the second communication device 410 is a UE.

In one embodiment, the second communication device 410 is network equipment.

In one embodiment, the second communication device 410 is a serving cell.

In one embodiment, the second communication device 410 is a TRP.

In one embodiment, the second communication device 410 supports the maintenance of multiple TRPs.

In one embodiment, at least the first four of the antenna 452, the receiver 454, the multi-antenna receiving processor 458, the receiving processor 456 and the controller/processor 459 are used for receiving the first message, the first message being used to determine a first reference signal resource pool, the first reference signal resource pool comprising at least one reference signal resource; at least the first four of the antenna 420, the transmitter 418, the multi-antenna transmitting processor 471, the transmitting processor 416 and the controller/processor 475 are used for transmitting the first message, the first message being used to determine a first reference signal resource pool, the first reference signal resource pool comprising at least one reference signal resource.

In one embodiment, at least the first four of the antenna 452, the transmitter 454, the multi-antenna transmitting processor 457, the transmitting processor 468 and the controller/processor 459 are used for transmitting a first radio signal for beam management, the first radio signal indicating a first reference signal resource; at least the first four of the antenna 420, the receiver 418, the multi-antenna receiving processor 472, the receiving processor 470 and the controller/processor 475 are used for receiving a first radio signal for beam management, the first radio signal indicating a first reference signal resource.

In one embodiment, at least the first four of the antenna 452, the transmitter 454, the multi-antenna transmitting processor 457, the transmitting processor 468 and the controller/processor 459 are used for determining a first target reference signal resource set from the first reference signal resource pool according to at least the first reference signal resource; at least the first four of the antenna 420, the receiver 418, the multi-antenna receiving processor 472, the receiving processor 470 and the controller/processor 475 are used for determining a first target reference signal resource set from the first reference signal resource pool according to at least the first reference signal resource.

In one embodiment, at least the first four of the antenna 452, the receiver 454, the multi-antenna receiving processor 458, the receiving processor 456, and the controller/processor 459 are used for incrementing a first counter by 1 whenever a first-type radio link quality evaluated according to the first target reference signal resource set is worse than a first threshold.

In one embodiment, at least the first four of the antenna 452, the transmitter 454, the multi-antenna transmitting processor 457, the transmitting processor 468 and the controller/processor 459 are used for transmitting a second radio signal as a response to the first counter reaching a first value, the second radio signal being used for beam failure recovery; at least the first four of the antenna 420, the receiver 418, the multi-antenna receiving processor 472, the receiving processor 470 and the controller/processor 475 are used for receiving a second radio signal, the second radio signal being used for beam failure recovery.

In one embodiment, at least the first four of the antenna 452, the receiver 454, the multi-antenna receiving processor 458, the receiving processor 456, and the controller/processor 459 are used for receiving a first signaling; at least the first four of the antenna 420, the transmitter 418, the multi-antenna transmitting processor 471, the transmitting processor 416 and the controller/processor 475 are used for transmitting a first signaling.

In one embodiment, at least the first four of the antenna 452, the receiver 454, the multi-antenna receiving processor 458, the receiving processor 456, and the controller/processor 459 are used for receiving a second signaling in a first time-frequency resource set; at least the first four of the antenna 420, the transmitter 418, the multi-antenna transmitting processor 471, the transmitting processor 416 and the controller/processor 475 are used for transmitting a second signaling in a first time-frequency resource set.

In one embodiment, at least the first four of the antenna 452, the receiver 454, the multi-antenna receiving processor 458, the receiving processor 456, and the controller/processor 459 are used for updating a reference signal resource associated with a first TCI State to the first reference signal resource; at least the first four of the antenna 420, the transmitter 418, the multi-antenna transmitting processor 471, the transmitting processor 416 and the controller/processor 475 are used for updating a reference signal resource associated with a first TCI State to the first reference signal resource.

In one embodiment, at least the first four of the antenna 452, the receiver 454, the multi-antenna receiving processor 458, the receiving processor 456, and the controller/processor 459 are used for updating the second reference signal resource in the second reference signal resource pool; at least the first four of the antenna 420, the transmitter 418, the multi-antenna transmitting processor 471, the transmitting processor 416 and the controller/processor 475 are used for updating the second reference signal resource in the second reference signal resource pool.

### Embodiment 5

Embodiment 5 illustrates a flowchart of a first message, as shown in FIG. 5. In FIG. 5, a first node U1 and a second node N2 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 5 can be applied to either of Embodiments 6 or 7; conversely, in case of no conflict, the embodiments, sub-embodiments, and subsidiary embodiments in either of Embodiments 6 or 7 can be applied to Embodiment 5.

The first node U1 receives a first message in step S10; and transmits a first radio signal in step S11, and in step S12 determines a first target reference signal resource set from the first reference signal resource pool according to at least the first reference signal resource; and in step S13, whenever a first-type radio link quality evaluated according to the first target reference signal resource set is worse than a first threshold, increments a first counter by 1; and transmits a second radio signal in step S14.

The second node N2 transmits a first message in step S20; receives a first radio signal in step S21; and receives a second radio signal in step S22.

In Embodiment 5, the first message is used to determine the first reference signal resource pool, the first reference signal resource pool comprising at least one reference signal resource; the first radio signal belongs to a beam management procedure; the first radio signal indicates the first reference signal resource; the second radio signal is transmitted as a response to the first counter reaching a first value, the second radio signal being used for beam failure recovery; the second radio signal indicates a second reference signal resource; the second reference signal resource is related to the first target reference signal resource set.

In one embodiment, the first node U1 determines the first target reference signal resource set from a first reference signal resource pool according to at least the first reference signal resource.

In one embodiment, the second node N2 determines the first target reference signal resource set from a first reference signal resource pool according to at least the first reference signal resource.

In one embodiment, the first reference signal resource pool comprises a first reference signal resource set and a second reference signal resource set; the first reference signal resource set and the second reference signal resource set are respectively associated with a first PCI and a second PCI; when the first reference signal resource is associated with the first PCI, the first target reference signal resource set is the first reference signal resource set; when the first reference signal resource is associated with the second PCI, the first target reference signal resource set is the second reference signal resource set.

In one subembodiment, the meaning of the phrase that the first reference signal resource is associated with the first PCI includes: an RRC signaling configuring the first reference signal resource includes the first PCI.

In one subembodiment, the meaning of the phrase that the first reference signal resource is associated with the first PCI includes: the first reference signal resource is transmitted by a TRP corresponding to the first

PCI.

In one subembodiment, the meaning of the phrase that the first reference signal resource is associated with the first PCI includes: the first reference signal resource is maintained by a TRP corresponding to the first PCI.

In one subembodiment, the meaning of the phrase that the first reference signal resource is associated with the second PCI includes: an RRC signaling configuring the first reference signal resource includes the second PCI.

In one subembodiment, the meaning of the phrase that the first reference signal resource is associated with the second PCI includes: the first reference signal resource is transmitted by a TRP corresponding to the second PCI.

In one subembodiment, the meaning of the phrase that the first reference signal resource is associated with the second PCI includes: the first reference signal resource is maintained by a TRP corresponding to the second PCI.

In one subembodiment, the phrase of the first reference signal resource set associated with a first PCI comprises: each reference signal resource in the first reference signal resource set being associated with the first PCI.

In one subembodiment, the phrase of the first reference signal resource set associated with a first PCI comprises: all reference signal resources in the first reference signal resource set being associated with the first PCI.

In one subembodiment, the phrase of the first reference signal resource set associated with a first PCI comprises: the first reference signal resource set being for a cell identified by the first PCI.

In one subembodiment, the phrase of the first reference signal resource set associated with a first PCI comprises: the first reference signal resource set being associated with at least one TRP in the first PCI.

In one subembodiment, the phrase of the first reference signal resource set associated with a first PCI comprises: the first reference signal resource set being only associated with one TRP in the first PCI.

In one subembodiment, the phrase of the first reference signal resource set associated with a first PCI comprises: the first reference signal resource set being associated with all TRPs in the first PCI.

In one subembodiment, the phrase of the second reference signal resource set associated with a second PCI comprises: each reference signal resource in the second reference signal resource set being associated with the second PCI.

In one subembodiment, the phrase of the second reference signal resource set associated with a second PCI comprises: all reference signal resources in the second reference signal resource set being associated with the second PCI.

In one subembodiment, the phrase of the second reference signal resource set associated with a second PCI comprises: the second reference signal resource set being for a cell identified by the second PCI.

In one embodiment, the phrase of the second reference signal resource set associated with a second PCI comprises: the second reference signal resource set being associated with at least one TRP in the second PCI.

In one embodiment, the phrase of the second reference signal resource set associated with a second PCI comprises: the second reference signal resource set being only associated with one TRP in the second PCI.

In one subembodiment, the phrase of the second reference signal resource set associated with a second PCI comprises: the second reference signal resource set being associated with all TRPs in the second PCI.

In one subembodiment, the first reference signal resource set comprises M2 reference signal resources, M2 being a positive integer greater than 1.

In one subsidiary embodiment of the above subembodiment, at least one of the M2 reference signal resources is a CSI-RS resource.

In one subsidiary embodiment of the above subembodiment, at least one of the M2 reference signal resources is an SSB resource.

In one subsidiary embodiment of the above subembodiment, at least one of the M2 reference signal resources is an SS/PBCH block.

In one subsidiary embodiment of the above subembodiment, at least one of the M2 reference signal resources corresponds to a TCI-State.

In one subsidiary embodiment of the above subembodiment, at least one of the M2 reference signal resources corresponds to a TCI-StateId.

In one subsidiary embodiment of the above subembodiment, any one of the M2 reference signal resources is periodic.

In one subembodiment, any one of the M2 reference signal resources is aperiodic.

In one subsidiary embodiment of the above subembodiment, any one of the M2 reference signal resources is QCL-Type D.

In one subsidiary embodiment of the above subembodiment, one reference signal resource among the M2 reference signal resources is a CSI-RS resource identified by csi-RS-Index, or the reference signal resource is an SSB resource identified by ssb-Index.

In one subsidiary embodiment of the above subembodiment, one reference signal resource among the M2 reference signal resources is a CSI-RS resource identified by csi-rs, or the reference signal resource is an SSB resource identified by ssb.

In one subsidiary embodiment of the above subembodiment, one reference signal resource among the M2 reference signal resources is a CSI-RS resource identified by NZP-CSI-RS-ResourceId, or the reference signal resource is an SSB resource identified by SSB-Index.

In one subembodiment, the second reference signal resource set comprises M3 reference signal resources, M3 being a positive integer greater than 1.

In one subsidiary embodiment of the above subembodiment, at least one of the M3 reference signal resources is a CSI-RS resource.

In one subsidiary embodiment of the above subembodiment, at least one of the M3 reference signal resources is an SSB resource.

In one subsidiary embodiment of the above subembodiment, at least one of the M3 reference signal resources is an SS/PBCH block.

In one subsidiary embodiment of the above subembodiment, at least one of the M3 reference signal resources corresponds to a TCI-State.

In one subsidiary embodiment of the above subembodiment, at least one of the M3 reference signal resources corresponds to a TCI-StateId.

In one subsidiary embodiment of the above subembodiment, any one of the M3 reference signal resources is periodic.

In one subsidiary embodiment of the above subembodiment, any one of the M3 reference signal resources is aperiodic.

In one subsidiary embodiment of the above subembodiment, any one of the M3 reference signal resources is QCL-Type D.

In one subsidiary embodiment of the above subembodiment, one reference signal resource among the M3 reference signal resources is a CSI-RS resource identified by csi-RS-Index, or the reference signal resource is an SSB resource identified by ssb-Index.

In one subsidiary embodiment of the above subembodiment, one reference signal resource among the M3 reference signal resources is a CSI-RS resource identified by csi-rs, or the reference signal resource is an SSB resource identified by ssb.

In one subsidiary embodiment of the above subembodiment, one reference signal resource among the M3 reference signal resources is a CSI-RS resource identified by NZP-CSI-RS-ResourceId, or the reference signal resource is an SSB resource identified by SSB-Index.

In one subembodiment, the first PCI is a non-negative integer.

In one subembodiment, the second PCI is a non-negative integer.

In one embodiment, the second reference signal resource is the first reference signal resource.

In one subembodiment, the meaning of the phrase that the second reference signal resource is the first reference signal resource comprises: a reference signal corresponding to the second reference signal resource and a reference signal corresponding to the first reference signal resource occupy the same time-frequency resources.

In one subembodiment, the meaning of the phrase that the second reference signal resource is the first reference signal resource comprises: a TCI-StateId corresponding to the second reference signal resource is the same as a TCI-StateId corresponding to the first reference signal resource.

In one subembodiment, the meaning of the phrase that the second reference signal resource is the first reference signal resource comprises: the second reference signal resource and the first reference signal resource are QCL.

In one subembodiment, the meaning of the phrase that the second reference signal resource is the first reference signal resource comprises: a second identifier corresponding to the second reference signal resource is related to a first identifier corresponding to the first reference signal resource.

In one subsidiary embodiment of the above subembodiment, the second identifier being related to the first identifier includes that the second identifier is the same as the first identifier.

In one subsidiary embodiment of the above subembodiment, the second identifier being related to the first identifier includes that the second identifier and the first identifier belong to QCL-Info in a same TCI-State IE.

In one subsidiary embodiment of the above subembodiment, the first identifier is either of NZP-CSI-RS-ResourceId or SSB-Index.

In one subsidiary embodiment of the above subembodiment, the second identifier is either of NZP-CSI-RS-ResourceId or SSB-Index.

In one embodiment, the second reference signal resource is a reference signal resource in a second target reference signal resource set; a second reference signal resource pool comprises a third reference signal resource set and a fourth reference signal resource set; the third reference signal resource set and the fourth reference signal resource set are respectively associated with a first PCI and a second PCI; when the first target reference signal resource set is associated with the first PCI, the second target reference signal resource set is the third reference signal resource set; when the first target reference signal resource set is associated with the second PCI, the second target reference signal resource set is the fourth reference signal resource set.

In one subembodiment, the second reference signal resource pool is at least one q̅₁ in TS 38.213.

In one subembodiment, the second reference signal resource pool corresponds to at least one q̅₁ in TS 38.213.

In one subembodiment, the second reference signal resource pool is two q̅₁ s in TS 38.213.

In one subembodiment, the second reference signal resource pool corresponds to two q̅₁s in TS 38.213.

In one subembodiment, the second reference signal resource pool is configured on one BWP.

In one subembodiment, the second reference signal resource pool is configured via an RRC signaling.

In one subembodiment, the second reference signal resource pool is configured via a BeamFailureRecoveryConfig IE.

In one subembodiment, the name of an RRC signaling that configures the second reference signal resource pool includes Beam.

In one subembodiment, the name of an RRC signaling that configures the second reference signal resource pool includes Failure.

In one subembodiment, the name of an RRC signaling that configures the second reference signal resource pool includes Recovery.

In one subembodiment, the second reference signal resource pool is configured via candidateBeamRSList in TS 38.331.

In one subembodiment, the second reference signal resource pool is configured via candidateBeamResourceList in TS 38.331.

In one subembodiment, all reference signal resources that are likely to be selected as the second reference signal resource form the second reference signal resource pool.

In one subembodiment, the meaning of the phrase of the third reference signal resource set associated with a first PCI includes: each reference signal resource in the third reference signal resource set being associated with the first PCI.

In one subembodiment, the meaning of the phrase of the third reference signal resource set associated with a first PCI includes: all reference signal resources in the third reference signal resource set being associated with the first PCI.

In one subembodiment, the meaning of the phrase of the third reference signal resource set associated with a first PCI includes: the third reference signal resource set being for a cell identified by the first PCI.

In one subembodiment, the meaning of the phrase of the third reference signal resource set associated with a first PCI includes: the third reference signal resource set being associated with at least one TRP in the first PCI.

In one subembodiment, the meaning of the phrase of the third reference signal resource set associated with a first PCI includes: the third reference signal resource set being only associated with one TRP in the first PCI.

In one subembodiment, the meaning of the phrase of the third reference signal resource set associated with a first PCI includes: the third reference signal resource set being associated with all TRPs in the first PCI.

In one subembodiment, the meaning of the phrase of the fourth reference signal resource set associated with a second PCI includes: each reference signal resource in the fourth reference signal resource set being associated with the second PCI.

In one subembodiment, the meaning of the phrase of the fourth reference signal resource set associated with a second PCI includes: all reference signal resources in the fourth reference signal resource set being associated with the second PCI.

In one subembodiment, the meaning of the phrase of the fourth reference signal resource set associated with a second PCI includes: the fourth reference signal resource set being for a cell identified by the second PCI.

In one subembodiment, the meaning of the phrase of the fourth reference signal resource set associated with a second PCI includes: the fourth reference signal resource set being associated with at least one TRP in the second PCI.

In one subembodiment, the meaning of the phrase of the fourth reference signal resource set associated with a second PCI includes: the fourth reference signal resource set being only associated with one TRP in the second PCI.

In one subembodiment, the meaning of the phrase of the fourth reference signal resource set associated with a second PCI includes: the fourth reference signal resource set being associated with all TRPs in the second PCI.

In one subembodiment, the third reference signal resource set comprises Q2 reference signal resources, Q2 being a positive integer greater than 1.

In one subsidiary embodiment of the above subembodiment, at least one of the Q2 reference signal resources is a CSI-RS resource.

In one subsidiary embodiment of the above subembodiment, at least one of the Q2 reference signal resources is an SSB resource.

In one subsidiary embodiment of the above subembodiment, at least one of the Q2 reference signal resources is an SS/PBCH block.

In one subsidiary embodiment of the above subembodiment, at least one of the Q2 reference signal resources corresponds to a TCI-State.

In one subsidiary embodiment of the above subembodiment, at least one of the Q2 reference signal resources corresponds to a TCI-StateId.

In one subsidiary embodiment of the above subembodiment, any one of the Q2 reference signal resources is periodic.

In one subembodiment, any one of the Q2 reference signal resources is aperiodic.

In one subsidiary embodiment of the above subembodiment, any one of the Q2 reference signal resources is QCL-Type D.

In one subsidiary embodiment of the above subembodiment, one reference signal resource among the Q2 reference signal resources is a CSI-RS resource identified by csi-RS-Index, or the reference signal resource is an SSB resource identified by ssb-Index.

In one subsidiary embodiment of the above subembodiment, one reference signal resource among the Q2 reference signal resources is a CSI-RS resource identified by csi-rs, or the reference signal resource is an SSB resource identified by ssb.

In one subsidiary embodiment of the above subembodiment, one reference signal resource among the Q2 reference signal resources is a CSI-RS resource identified by NZP-CSI-RS-ResourceId, or the reference signal resource is an SSB resource identified by SSB-Index.

In one subembodiment, the fourth reference signal resource set comprises Q3 reference signal resources, Q3 being a positive integer greater than 1.

In one subsidiary embodiment of the above subembodiment, at least one of the Q3 reference signal resources is a CSI-RS resource.

In one subsidiary embodiment of the above subembodiment, at least one of the Q3 reference signal resources is an SSB resource.

In one subsidiary embodiment of the above subembodiment, at least one of the Q3 reference signal resources is an SS/PBCH block.

In one subsidiary embodiment of the above subembodiment, at least one of the Q3 reference signal resources corresponds to a TCI-State.

In one subsidiary embodiment of the above subembodiment, at least one of the Q3 reference signal resources corresponds to a TCI-StateId.

In one subsidiary embodiment of the above subembodiment, any one of the Q3 reference signal resources is periodic.

In one subsidiary embodiment of the above subembodiment, any one of the Q3 reference signal resources is aperiodic.

In one subsidiary embodiment of the above subembodiment, any one of the Q3 reference signal resources is QCL-Type D.

In one subsidiary embodiment of the above subembodiment, one reference signal resource among the Q3 reference signal resources is a CSI-RS resource identified by csi-RS-Index, or the reference signal resource is an SSB resource identified by ssb-Index.

In one subsidiary embodiment of the above subembodiment, one reference signal resource among the Q3 reference signal resources is a CSI-RS resource identified by csi-rs, or the reference signal resource is an SSB resource identified by ssb.

In one subsidiary embodiment of the above subembodiment, one reference signal resource among the Q3 reference signal resources is a CSI-RS resource identified by NZP-CSI-RS-ResourceId, or the reference signal resource is an SSB resource identified by SSB-Index.

In one subembodiment, the meaning of the phrase of the first target reference signal resource set associated with a first PCI includes: each reference signal resource in the first target reference signal resource set being associated with the first PCI.

In one subembodiment, the meaning of the phrase of the first target reference signal resource set associated with a first PCI includes: all reference signal resources in the first target reference signal resource set being associated with the first PCI.

In one subembodiment, the meaning of the phrase of the first target reference signal resource set associated with a first PCI includes: the first target reference signal resource set being for a cell identified by the first PCI.

In one subembodiment, the meaning of the phrase of the first target reference signal resource set associated with a first PCI includes: the first target reference signal resource set being associated with at least one TRP in the first PCI.

In one subembodiment, the meaning of the phrase of the first target reference signal resource set associated with a first PCI includes: the first target reference signal resource set being only associated with one TRP in the first PCI.

In one subembodiment, the meaning of the phrase of the first target reference signal resource set associated with a first PCI includes: the first target reference signal resource set being associated with all TRPs in the first PCI.

In one subembodiment, the meaning of the phrase of the first target reference signal resource set associated with a second PCI includes: each reference signal resource in the first target reference signal resource set being associated with the second PCI.

In one subembodiment, the meaning of the phrase of the first target reference signal resource set associated with a second PCI includes: all reference signal resources in the first target reference signal resource set being associated with the second PCI.

In one subembodiment, the meaning of the phrase of the first target reference signal resource set associated with a second PCI includes: the first target reference signal resource set being for a cell identified by the second PCI.

In one subembodiment, the meaning of the phrase of the first target reference signal resource set associated with a second PCI includes: the first target reference signal resource set being associated with at least one TRP in the second PCI.

In one subembodiment, the meaning of the phrase of the first target reference signal resource set associated with a second PCI includes: the first target reference signal resource set being only associated with one TRP in the second PCI.

In one subembodiment, the meaning of the phrase of the first target reference signal resource set associated with a second PCI includes: the first target reference signal resource set being associated with all TRPs in the second PCI.

In one embodiment, the first node U1 updates a reference signal resource associated with a first TCI state to the first reference signal resource, the first radio signal being used to determine the first TCI state.

In one embodiment, the second node N2 updates a reference signal resource associated with a first TCI state to the first reference signal resource, the first radio signal being used to determine the first TCI state.

In one subembodiment of the above two embodiments, before the first node U1 transmits the first radio signal, the first TCI state is associated with a reference signal resource other than the first reference signal resource.

In one subembodiment of the above two embodiments, before the second node N2 receives the first radio signal, the first TCI state is associated with a reference signal resource other than the first reference signal resource.

In one subembodiment of the above two embodiments, the first TCI state corresponds to a TCI-StateId.

In one subembodiment of the above two embodiments, the operation of updating the reference signal resource associated with the first TCI state to the first reference signal resource is done at the first node.

In one subembodiment of the above two embodiments, before updating the reference signal resource associated with the first TCI state to the first reference signal resource, the first node U1 doesn't have to wait for an acknowledgment from the second node N2 for the first radio signal.

In one subembodiment of the above two embodiments, before updating the reference signal resource associated with the first TCI state to the first reference signal resource, the first node U1 doesn't have to wait for the first signaling in the present application.

In one subembodiment of the above two embodiments, the first radio signal is used to indicate the first TCI.

In one embodiment, when the first node U1 transmits the second radio signal, the second reference signal resource is updated in the second reference signal resource pool.

In one embodiment, when the second node N2 receives the second radio signal, the second reference signal resource is updated in the second reference signal resource pool.

In one subembodiment of the above two embodiments, the meaning of the phrase that the second reference signal resource is updated in the second reference signal resource pool comprises: the second reference signal resource is added to the third reference signal resource set.

In one subembodiment of the above two embodiments, the meaning of the phrase that the second reference signal resource is updated in the second reference signal resource pool comprises: the second reference signal resource is added to the fourth reference signal resource set.

In one subembodiment of the above two embodiments, the meaning of the phrase that the second reference signal resource is updated in the second reference signal resource pool comprises: the second reference signal resource pool comprises a third reference signal resource set and a fourth reference signal resource set; the third reference signal resource set and the fourth reference signal resource set are respectively associated with a first PCI and a second PCI; when the first reference signal resource is associated with the first PCI, the second reference signal resource is added to the third reference signal resource set; when the first reference signal resource is associated with the second PCI, the second reference signal resource is added to the fourth reference signal resource set.

### Embodiment 6

Embodiment 6 illustrates a flowchart of a first signaling, as shown in FIG. 6. In FIG. 6, a first node U3 and a second node N4 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 6 can be applied to either of Embodiments 5 or 7; conversely, in case of no conflict, the embodiments, sub-embodiments, and subsidiary embodiments in either of Embodiments 5 or 7 can be applied to Embodiment 6.

The first node U3 receives a first signaling in step S30.

The second node N4 transmits a first signaling in step S40.

In Embodiment 6, the first signaling is used to determine that a demodulation reference signal (DMRS) for a PDCCH in a control resource set 0 and the first reference signal resource are quasi co-located.

In one embodiment, the step S30 in Embodiment 6 is located after the step S11 and before the step S12 in Embodiment 5.

In one embodiment, the step S30 in Embodiment 6 is located after the step S14 in Embodiment 5.

In one embodiment, the step S40 in Embodiment 6 is located after the step S21 and before the step S12 in Embodiment 5.

In one embodiment, the step S30 in Embodiment 6 is located after the step S14 in Embodiment 5.

In one embodiment, the step S40 in Embodiment 6 is located after the step S21 and before the step S22 in Embodiment 5.

In one embodiment, the step S40 in Embodiment 6 is located after the step S22 in Embodiment 5.

In one embodiment, the first signaling is used to indicate that a demodulation reference signal (DMRS) for a PDCCH in a control resource set 0 and the first reference signal resource are quasi co-located.

In one embodiment, the first signaling is a HARQ-ACK for the first radio signal.

In one embodiment, the first signaling is a MAC CE.

In one embodiment, a physical layer channel occupied by the first signaling includes a PDCCH.

In one embodiment, a type of the quasi co-location in the present application includes QCL Type A.

In one embodiment, a type of the quasi co-location in the present application includes QCL Type B.

In one embodiment, a type of the quasi co-location in the present application includes QCL Type C.

In one embodiment, a type of the quasi co-location in the present application includes QCL Type D.

In one embodiment, the beam management in the present application includes receiving the first signaling.

In one embodiment, when the first node U3 receives the first signaling, the first node U3 determines the first target reference signal resource set from the first reference signal resource pool according to the first reference signal resource.

### Embodiment 7

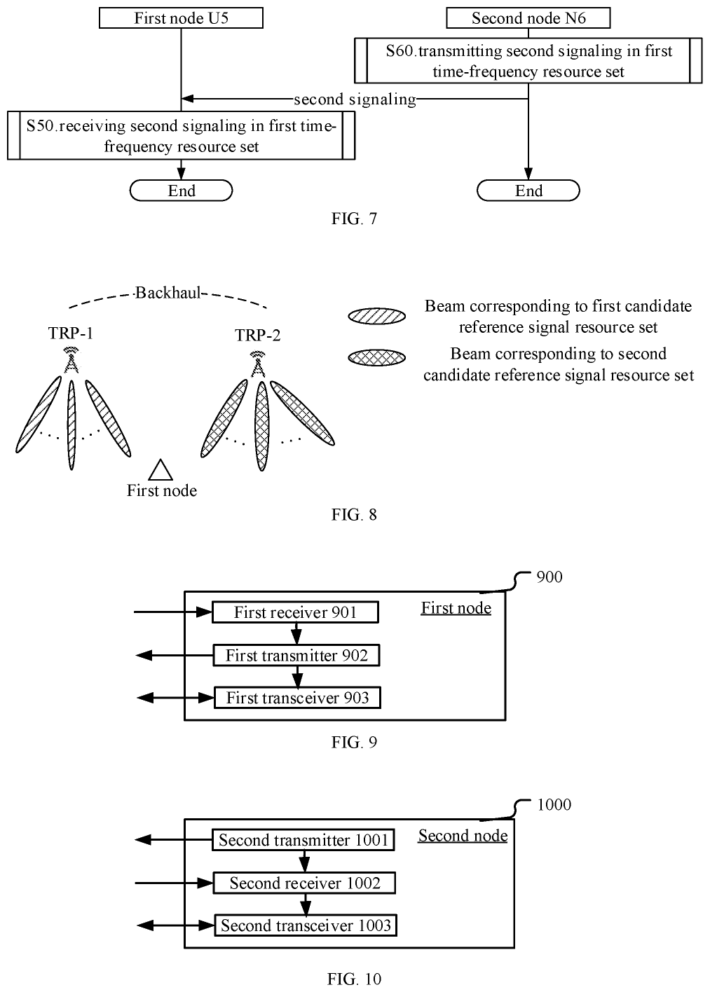

Embodiment 7 illustrates a flowchart of a second signaling, as shown in FIG. 7. In FIG. 7, a first node U5 and a second node N6 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 7 can be applied to either of Embodiments 5 or 6; conversely, in case of no conflict, the embodiments, sub-embodiments, and subsidiary embodiments in either of Embodiments 5 or 6 can be applied to Embodiment 7.

The first node U5 receives a second signaling in a first time-frequency resource set in step S50.

The second node N6 transmits the second signaling in the first time-frequency resource set in step S60.

In Embodiment 7, the first time-frequency resource set is associated with a control resource set 0, and the second reference signal resource and a demodulation reference signal included in the second time-frequency resource set are quasi co-located.

In one embodiment, the step S50 in Embodiment 7 is located after the step S14 in Embodiment 5.

In one embodiment, the step S60 in Embodiment 7 is located after the step S22 in Embodiment 5.

In one embodiment, the symbol in the present application is an Orthogonal Frequency Division Multiplexing (OFDM) Symbol.

In one embodiment, the symbol in the present application is a Single Carrier- Frequency Division Multiple Access (SC-FDMA) symbol.

In one embodiment, the symbol in the present application is a Filter Bank Multi Carrier (FBMC) symbol.

In one embodiment, the symbol in the present application is an OFDM symbol containing Cyclic Prefix (CP).

In one embodiment, the symbol in the present application is a Discrete Fourier Transform Spreading Orthogonal Frequency Division Multiplexing (DFT-s-OFDM) symbol containing CP.

In one embodiment, the first time-frequency resource set occupies frequency-domain resources corresponding to a positive integer number of Resource Block (RBs) in frequency domain, and the first time-frequency resource set occupies a positive integer number of symbol(s) in time domain.

In one embodiment, the first time-frequency resource set occupies more than one Resource Element (RE).

In one embodiment, the first node U5 receives the second signaling in the first time-frequency resource set after transmitting the second radio signal.

In one embodiment, the first node U5, after transmitting the second radio signal, assumes that a demodulation reference signal for a PDCCH in the control resource set 0 and the second reference signal resource are QCL.

In one embodiment, when and only when the second reference signal resource set is the first candidate reference signal resource set, the first node U5 assumes that a demodulation reference signal for a PDCCH in the control resource set 0 and the second reference signal resource are QCL.

In one embodiment, the above phrase that the first time-frequency resource set is associated with a control resource set 0 comprises: frequency-domain resources occupied by the first time-frequency resource set belonging to frequency-domain resources occupied by the control resource set 0.

In one embodiment, the above phrase that the first time-frequency resource set is associated with a control resource set 0 comprises: symbols occupied by the first time-frequency resource set belonging to symbols occupied by the control resource set 0.

In one embodiment, the above phrase that the first time-frequency resource set is associated with a control resource set 0 comprises: a slot in which the first time-frequency resource set is located belonging to a slot occupied by a search space associated with the control resource set 0.

In one embodiment, the first time-frequency resource set corresponds to a CORESET.

In one embodiment, the first time-frequency resource set corresponds to a search space set.

### Embodiment 8

Embodiment 8 illustrates a schematic of an application scenario, as shown in FIG. 8. In FIG. 8, both TRP-1 and TRP-2 shown are managed by the second node of the present application; the first PCI in the present application is associated with the TRP-1 and the second PCI in the present application is associated with the TRP-2; and the first node moves in the coverage of the TRP-1 and in the coverage of the TRP-2.

In one embodiment, when the first node moves from the coverage of the TRP-1 into the coverage of the TRP-2, the first reference signal resource is one reference signal resource in the second candidate reference signal resource set.

In one sub-embodiment, the second candidate reference signal resource set is the second reference signal resource set in this application.

In one embodiment, when the first node moves from the coverage of the TRP-1 into the coverage of the TRP-2, the second reference signal resource is one reference signal resource in the second candidate reference signal resource set.

In one subembodiment, the second candidate reference signal resource set is the fourth reference signal resource set in this application.

In one embodiment, when the first node moves from the coverage of the TRP-2 into the coverage of the TRP-1, the first reference signal resource is one reference signal resource in the first candidate reference signal resource set.

In one subembodiment, the first candidate reference signal resource set is the first reference signal resource set in this application.

In one embodiment, when the first node moves from the coverage of the TRP-2 into the coverage of the TRP-1, the second reference signal resource is one reference signal resource in the first candidate reference signal resource set.

In one subembodiment, the first candidate reference signal resource set is the third reference signal resource set in this application.

### Embodiment 9

Embodiment 9 illustrates a structure block diagram of a first node, as shown in FIG. 9. In FIG. 9, a first node 900 comprises a first receiver 901, a first transmitter 902 and a first transceiver 903.

The first receiver 901 receives a first message, the first message being used to determine a first reference signal resource pool, the first reference signal resource pool comprising at least one reference signal resource;
the first transmitter 902 transmits a first radio signal for beam management, the first radio signal indicating a first reference signal resource; and determining a first target reference signal resource set from the first reference signal resource pool according to at least the first reference signal resource;
the first transceiver 903, whenever a first-type radio link quality evaluated according to the first target reference signal resource set is worse than a first threshold, increments a first counter by 1; and as a response to the first counter reaching a first value, transmitting a second radio signal, the second radio signal being used for beam failure recovery.

In Embodiment 9, the second radio signal indicates a second reference signal resource; the second reference signal resource is related to the first target reference signal resource set.

In one embodiment, the first reference signal resource pool comprises a first reference signal resource set and a second reference signal resource set; the first reference signal resource set and the second reference signal resource set are respectively associated with a first physical cell identifier and a second physical cell identifier; when the first reference signal resource is associated with the first physical cell identifier, the first target reference signal resource set is the first reference signal resource set; when the first reference signal resource is associated with the second physical cell identifier, the first target reference signal resource set is the second reference signal resource set.

In one embodiment, the second reference signal resource is a reference signal resource in a second target reference signal resource set; a second reference signal resource pool comprises a third reference signal resource set and a fourth reference signal resource set; the third reference signal resource set and the fourth reference signal resource set are respectively associated with a first physical cell identifier and a second physical cell identifier; when the first target reference signal resource set is associated with the first physical cell identifier, the second target reference signal resource set is the third reference signal resource set; when the first target reference signal resource set is associated with the second physical cell identifier, the second target reference signal resource set is the fourth reference signal resource set.

In one embodiment, the first transceiver 903 receives a first signaling; the first signaling is used to determine that a demodulation reference signal (DMRS) for a Physical Downlink Control Channel (PDCCH) in a control resource set 0 and the first reference signal resource are quasi co-located.

In one embodiment, the first transceiver 903 receives a second signaling in a first time-frequency resource set; the first time-frequency resource set is associated with a control resource set 0, and the second reference signal resource and a demodulation reference signal included in the first time-frequency resource set are quasi co-located.

In one embodiment, the second reference signal resource is the first reference signal resource, or the second reference signal resource is quasi co-located with the first reference signal resource.

In one embodiment, the first transceiver 903 updates a reference signal resource associated with a first TCI state to the first reference signal resource, the first radio signal being used to determine the first TCI state.

In one embodiment, the first node updates a reference signal resource associated with a first TCI state to the first reference signal resource, the first radio signal being used to determine the first TCI state.

In one embodiment, when the first node transmits the second radio signal, the second reference signal resource is updated in the second reference signal resource pool.

In one embodiment, the first receiver 901 comprises at least the first four of the antenna 452, the receiver 454, the multi-antenna receiving processor 458, the receiving processor 456 and the controller/processor 459 in Embodiment 4.

In one embodiment, the first transmitter 902 comprises at least the first four of the antenna 452, the transmitter 454, the multi-antenna transmitting processor 457, the transmitting processor 468 and the controller/processor 459 in Embodiment 4.

In one embodiment, the first transceiver 903 comprises at least the first six of the antenna 452, the receiver/transmitter 454, the multi-antenna receiving processor 458, the multi-antenna transmitting processor 457, the receiving processor 456, the transmitting processor 468 and the controller/processor 459 in Embodiment 4.

### Embodiment 10

Embodiment 10 illustrates a structure block diagram of a second node, as shown in FIG. 10. In FIG. 10, a second node 1000 comprises a second transmitter 1001, a second receiver 1002 and a second transceiver 1003.

The second transmitter 1001 transmits a first message, the first message being used to determine a first reference signal resource pool, the first reference signal resource pool comprising at least one reference signal resource;
the second receiver 1002 receives a first radio signal for beam management, the first radio signal indicating a first reference signal resource; and determining a first target reference signal resource set from the first reference signal resource pool according to at least the first reference signal resource;
the second transceiver 1003 receives a second radio signal, the second radio signal being used for beam failure recovery.

In Embodiment 10, a receiver of the first message includes a first node; whenever a first-type radio link quality evaluated by the first node according to the first target reference signal resource set is worse than a first threshold, a first counter is incremented by 1; and as a response to the first counter reaching a first value, the first node transmits a second radio signal; the second radio signal indicates a second reference signal resource; the second reference signal resource is related to the first target reference signal resource set.

In one embodiment, the first reference signal resource pool comprises a first reference signal resource set and a second reference signal resource set; the first reference signal resource set and the second reference signal resource set are respectively associated with a first physical cell identifier and a second physical cell identifier; when the first reference signal resource is associated with the first physical cell identifier, the first target reference signal resource set is the first reference signal resource set; when the first reference signal resource is associated with the second physical cell identifier, the first target reference signal resource set is the second reference signal resource set.

In one embodiment, the second reference signal resource is a reference signal resource in a second target reference signal resource set; a second reference signal resource pool comprises a third reference signal resource set and a fourth reference signal resource set; the third reference signal resource set and the fourth reference signal resource set are respectively associated with a first physical cell identifier and a second physical cell identifier; when the first target reference signal resource set is associated with the first physical cell identifier, the second target reference signal resource set is the third reference signal resource set; when the first target reference signal resource set is associated with the second physical cell identifier, the second target reference signal resource set is the fourth reference signal resource set.

In one embodiment, the second transceiver 1003 transmits a first signaling; the first signaling is used to determine that a demodulation reference signal (DMRS) for a Physical Downlink Control Channel (PDCCH) in a control resource set 0 and the first reference signal resource are quasi co-located.

In one embodiment, the second transceiver 1003 transmits a second signaling in a first time-frequency resource set; the first time-frequency resource set is associated with a control resource set 0, and the second reference signal resource and a demodulation reference signal included in the first time-frequency resource set are quasi co-located.

In one embodiment, the second reference signal resource is the first reference signal resource, or the second reference signal resource is quasi co-located with the first reference signal resource.

In one embodiment, the second transceiver 1003 updates a reference signal resource associated with a first TCI state to the first reference signal resource, the first radio signal being used to determine the first TCI state.

In one embodiment, when the second node receives the second radio signal, the second reference signal resource is updated in the second reference signal resource pool.

In one embodiment, the second transmitter 1001 comprises at least the first four of the antenna 420, the transmitter 418, the multi-antenna transmitting processor 471, the transmitting processor 416 and the controller/processor 475 in Embodiment 4.

In one embodiment, the second receiver 1002 comprises at least the first four of the antenna 420, the receiver 418, the multi-antenna receiving processor 472, the receiving processor 470 and the controller/processor 475 in Embodiment 4.

In one embodiment, the second transceiver 1003 comprises at least the first six of the antenna 420, the transmitter/receiver 418, the multi-antenna transmitting processor 471, the multi-antenna receiving processor 472, the transmitting processor 416, the receiving processor 470 and the controller/processor 475 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits.

Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IOT terminals, vehicle-mounted communication equipment, vehicles, automobiles, RSU, aircrafts, airplanes, unmanned aerial vehicles, telecontrolled aircrafts, etc. The second node in the present application includes but is not limited to macro-cellular base stations, micro-cellular base stations, home base stations, relay base station, eNB, gNB, Transmitter Receiver Point (TRP), GNSS, relay satellite, satellite base station, airborne base station,

RSU, unmanned ariel vehicle, test equipment like transceiving device simulating partial functions of base station or signaling tester, and other radio communication equipment. It will be appreciated by those skilled in the art that this disclosure can be implemented in other designated forms without departing from the core features or fundamental characters thereof.

The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first message, the first message being used to determine a first reference signal resource pool, the first reference signal resource pool comprising at least one reference signal resource; and
a first transmitter, transmitting a first radio signal for beam management, the first radio signal indicating a first reference signal resource; and determining a first target reference signal resource set from the first reference signal resource pool according to at least the first reference signal resource; and
a first transceiver, whenever a first-type radio link quality evaluated according to the first target reference signal resource set is worse than a first threshold, incrementing a first counter by 1; and as a response to the first counter reaching a first value, transmitting a second radio signal, the second radio signal being used for beam failure recovery;
wherein the second radio signal indicates a second reference signal resource; the second reference signal resource is related to the first target reference signal resource set.

2. The first node according to claim 1, characterized in that the first reference signal resource pool comprises a first reference signal resource set and a second reference signal resource set; the first reference signal resource set and the second reference signal resource set are respectively associated with a first physical cell identifier and a second physical cell identifier; when the first reference signal resource is associated with the first physical cell identifier, the first target reference signal resource set is the first reference signal resource set; when the first reference signal resource is associated with the second physical cell identifier, the first target reference signal resource set is the second reference signal resource set.

3. The first node according to claim 1, characterized in that the second reference signal resource is a reference signal resource in a second target reference signal resource set; a second reference signal resource pool comprises a third reference signal resource set and a fourth reference signal resource set; the third reference signal resource set and the fourth reference signal resource set are respectively associated with a first physical cell identifier and a second physical cell identifier; when the first target reference signal resource set is associated with the first physical cell identifier, the second target reference signal resource set is the third reference signal resource set; when the first target reference signal resource set is associated with the second physical cell identifier, the second target reference signal resource set is the fourth reference signal resource set.

4. The first node according to claim 1, characterized in that the first transceiver receives a first signaling; the first signaling is used to determine that a demodulation reference signal (DMRS) for a Physical Downlink Control Channel (PDCCH) in a control resource set 0 and the first reference signal resource are quasi co-located.

5. The first node according to claim 1, characterized in that the first transceiver receives a second signaling in a first time-frequency resource set; the first time-frequency resource set is associated with a control resource set 0, and the second reference signal resource and a demodulation reference signal included in the first time-frequency resource set are quasi co-located.

6. The first node according to claim 1, characterized in that the first node updates a reference signal resource associated with a first TCI state to the first reference signal resource, the first radio signal being used to determine the first TCI state.

7. The first node according to claim 3, characterized in that when the first node transmits the second radio signal, the second reference signal resource is updated in the second reference signal resource pool.

8. The first node according to claim 1, characterized in that the beam management is not a part of beam failure detection and recovery procedure;
or the beam management does not include receiving indications from lower layers;
or the beam management does not include starting or restarting a timer as a response to receiving the indications from lower layers;
or the beam management does not include incrementing a first counter by 1 whenever a first-type radio link quality evaluated according to the first reference signal resource set is worse than a first threshold.

9. The first node according to claim 1, characterized in that the beam management includes changing a TCI state of a physical channel;
or the beam management includes changing a TCI state corresponding to a CORESET of a physical channel;
or the beam management includes changing a correspondence between a TCI and a reference signal resource,
or the beam management includes Channel State Information (CSI) reporting.

10. The first node according to claim 1, characterized in that the feedback for the first radio signal includes a Hybrid Automatic Repeat reQuest Acknowledgement (HARQ-ACK),
or the feedback for the first radio signal includes a PDCCH,
or the feedback for the first radio signal includes Medium Access Control (MAC) Control Elements (CE).

11. A second node for wireless communications, comprising:
a second transmitter, transmitting a first message, the first message being used to determine a first reference signal resource pool, the first reference signal resource pool comprising at least one reference signal resource; and
a second receiver, receiving a first radio signal for beam management, the first radio signal indicating a first reference signal resource; and determining a first target reference signal resource set from the first reference signal resource pool according to at least the first reference signal resource; and
a second transceiver, receiving a second radio signal, the second radio signal being used for beam failure recovery;
wherein a receiver of the first message includes a first node; whenever a first-type radio link quality evaluated by the first node according to the first target reference signal resource set is worse than a first threshold, a first counter is incremented by 1; and as a response to the first counter reaching a first value, the first node transmits a second radio signal; the second radio signal indicates a second reference signal resource; the second reference signal resource is related to the first target reference signal resource set.

12. The second node according to claim 11, characterized in that the first reference signal resource pool comprises a first reference signal resource set and a second reference signal resource set; the first reference signal resource set and the second reference signal resource set are respectively associated with a first physical cell identifier and a second physical cell identifier; when the first reference signal resource is associated with the first physical cell identifier, the first target reference signal resource set is the first reference signal resource set; when the first reference signal resource is associated with the second physical cell identifier, the first target reference signal resource set is the second reference signal resource set.

13. The second node according to claim 11, characterized in that the second reference signal resource is a reference signal resource in a second target reference signal resource set; a second reference signal resource pool comprises a third reference signal resource set and a fourth reference signal resource set; the third reference signal resource set and the fourth reference signal resource set are respectively associated with a first physical cell identifier and a second physical cell identifier; when the first target reference signal resource set is associated with the first physical cell identifier, the second target reference signal resource set is the third reference signal resource set; when the first target reference signal resource set is associated with the second physical cell identifier, the second target reference signal resource set is the fourth reference signal resource set.

14. The second node according to claim 11, characterized in that the second transceiver transmits a first signaling; the first signaling is used to determine that a demodulation reference signal (DMRS) for a PDCCH in a control resource set 0 and the first reference signal resource are quasi co-located.

15. The second node according to claim 11, characterized in that the second transceiver transmits a second signaling in a first time-frequency resource set; the first time-frequency resource set is associated with a control resource set 0, and the second reference signal resource and a demodulation reference signal included in the first time-frequency resource set are quasi co-located.

16. The second node according to claim 11, characterized in that the second transceiver updates a reference signal resource associated with a first TCI state to the first reference signal resource, the first radio signal being used to determine the first TCI state.

17. The second node according to claim 13, characterized in that when the second node receives the second radio signal, the second reference signal resource is updated in the second reference signal resource pool.

18. A method in a first node for wireless communications, comprising:
receiving a first message, the first message being used to determine a first reference signal resource pool, the first reference signal resource pool comprising at least one reference signal resource; and
transmitting a first radio signal for beam management, the first radio signal indicating a first reference signal resource; and determining a first target reference signal resource set from the first reference signal resource pool according to at least the first reference signal resource; and
whenever a first-type radio link quality evaluated according to the first target reference signal resource set is worse than a first threshold, incrementing a first counter by 1; and as a response to the first counter reaching a first value, transmitting a second radio signal, the second radio signal being used for beam failure recovery;
wherein the second radio signal indicates a second reference signal resource; the second reference signal resource is related to the first target reference signal resource set.

19. The method in the first node according to claim 18, characterized in that the first reference signal resource pool comprises a first reference signal resource set and a second reference signal resource set; the first reference signal resource set and the second reference signal resource set are respectively associated with a first physical cell identifier and a second physical cell identifier; when the first reference signal resource is associated with the first physical cell identifier, the first target reference signal resource set is the first reference signal resource set; when the first reference signal resource is associated with the second physical cell identifier, the first target reference signal resource set is the second reference signal resource set.

20. The method in the first node according to claim 18, characterized in that the second reference signal resource is a reference signal resource in a second target reference signal resource set; a second reference signal resource pool comprises a third reference signal resource set and a fourth reference signal resource set; the third reference signal resource set and the fourth reference signal resource set are respectively associated with a first physical cell identifier and a second physical cell identifier; when the first target reference signal resource set is associated with the first physical cell identifier, the second target reference signal resource set is the third reference signal resource set; when the first target reference signal resource set is associated with the second physical cell identifier, the second target reference signal resource set is the fourth reference signal resource set.
